(19) United States
(12) Patent Application Publication
(10) Pub. No.: US 2024/0198498 A1
(43) Pub. Date: Jun. 20, 2024

(54) ELECTRIC RATCHET WRENCH

(71) Applicant: BASSO INDUSTRY CORP., Taichung (TW)

(72) Inventors: Tian-Chi LAI, Taichung (TW); San-Yih SU, Taichung (TW); Yao-Sheng SHEN, Taichung (TW)

(73) Assignee: BASSO INDUSTRY CORP., Taichung (TW)

(21) Appl. No.: 18/537,359

(22) Filed: Dec. 12, 2023

(30) Foreign Application Priority Data
Dec. 15, 2022 (TW) 111148308

(51) Int. Cl. B25B 21/00; B25B 23/147; B25B 23/16

(52) U.S. Cl. CPC B25B 21/004; B25B 23/147; B25B 23/16

(57) ABSTRACT

An electric ratchet wrench includes a tool head unit, a wrench body unit, an output unit, an electric unit, and a sensor unit. The wrench body unit includes a main body portion, and an installation portion connected between the tool head unit and the main body portion. The output unit includes a head driver mounted on the tool head unit, and being configured to rotate in a selected direction and output rotational energy. The sensor unit includes a transmitting handle pivotably connected to the main body portion, and at least one sensor module disposed between the main body portion and the transmitting handle. When the transmitting handle is driven by an external force to pivot relative to the main body portion, the sensor module outputs a torque reading of the external force.

### CROSS-REFERENCE TO RELATED APPLICATION

This application claims priority to Taiwanese Invention Patent Application No. 111148308, filed on Dec. 15, 2022, the entire disclosure of which is incorporated by reference herein.

### FIELD

The disclosure relates to an electric ratchet wrench, and more particularly to an electric ratchet wrench with torque sensor.

### BACKGROUND

A conventional electric ratchet wrench is electrically powered to fasten screws or nuts, and derives its popular appeal from the labor-saving advantage that it provides. However, a torque force produced by the conventional electric ratchet wrench is limited by the electric power that is supplied to the conventional electric ratchet wrench; thus, when there is no electric power or the torque requirements of the task at hand exceed the output range of the conventional electric ratchet wrench, most of the conventional electric ratchet wrenches that are commercially available also allow manual operation in addition to electrically powered operation.

When manually operating the conventional electric ratchet wrench, some of the conventional electric ratchet wrenches may sense and display torque values to prevent incorrect output. For example, a conventional electric ratchet wrench as disclosed in US Patent Publication No. 10625405 uses a strain gauge to sense the torque values. Specifically, the strain gauge bends and creates a change in electrical conductance of the strain gauge, then the conventional electric ratchet wrench calculates a torque value applied on the screw or nut in accordance.

By mounting the strain gauge proximal to a tool head unit and by weakening the structure of a portion of the conventional ratchet wrench that contains the strain gauge, accuracy in sensing torques increases; however, due to the strain gauge being proximal to the tool head unit, vibrations generated during operations may cause the torque values to deviate or even damage the strain gauge, and the weakened structure of the electric ratchet wrench lowers the overall strength and sensing reliability of the conventional electric ratchet wrench.

### SUMMARY

Therefore, an object of the disclosure is to provide an electric ratchet wrench that can alleviate at least one of the drawbacks of the prior art.

According to the disclosure, the electric ratchet wrench includes a tool head unit, a wrench body unit, an output unit, an electric unit, and a sensor unit. The wrench body unit extends along a first axis, and includes a main body portion and an installation portion connected between the tool head unit and the main body portion. The output unit includes a head driver mounted on the tool head unit, extending along a second axis that is transverse to the first axis, and being configured to rotate in a selected direction and output rotational energy. The electric unit is mounted in the installation portion, and is operable for driving rotation of the head driver. The sensor unit includes a transmitting handle and at least one sensor module. The transmitting handle is pivotably connected to the main body portion. The at least one sensor module is disposed between the main body portion and the transmitting handle. When the transmitting handle is driven by an external force to pivot relative to the main body portion, the sensor module outputs a torque reading of the external force.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a side view illustrating a first embodiment of an electric ratchet wrench according to the disclosure.

FIG. 2 is a sectional view of the first embodiment.

FIG. 3 is a partly exploded perspective view of the first embodiment.

FIG. 4 is a sectional view of the first embodiment taken along line IV-IV in FIG. 2.

FIG. 5 is an enlarged fragmentary sectional view of the first embodiment.

FIG. 6 is a view similar to FIG. 5, but illustrating a transmitting handle pivotally moved relative to a main body portion of a wrench body unit.

FIG. 7 is a view similar to FIG. 5, but illustrating a variation of a sensor unit.

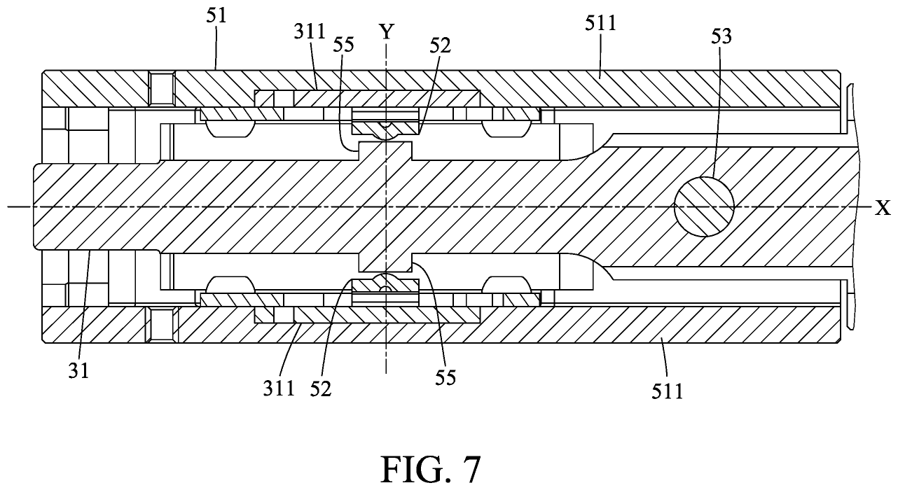

FIG. 8 is a partly exploded perspective view illustrating a second embodiment of the electric ratchet wrench according to the disclosure.

FIG. 9 is a perspective view of the second embodiment.

FIG. 10 is an enlarged fragmentary sectional view of the second embodiment.

FIG. 11 is a view similar to FIG. 10, but illustrating a transmitting handle pivotally moved relative to a main body portion of a wrench body unit.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

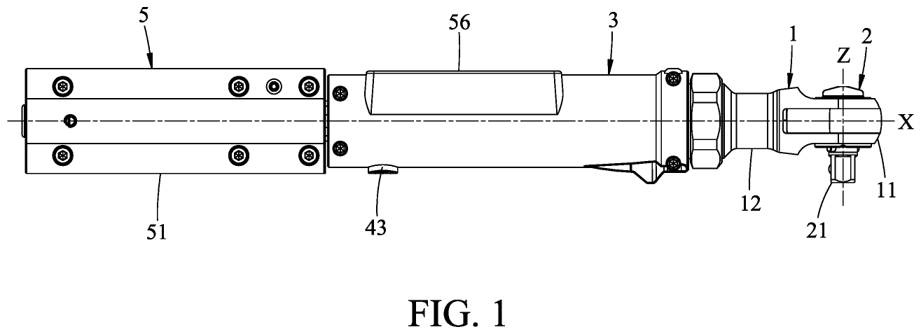

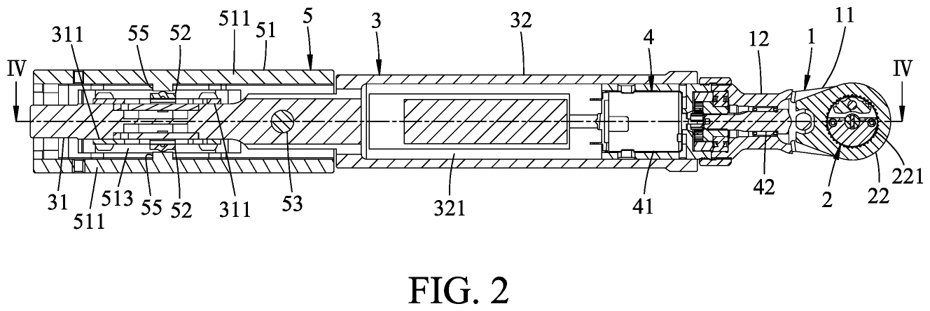

Referring to FIGS. 1 and 2, a first embodiment of the electric ratchet wrench according to the disclosure includes a tool head unit 1, an output unit 2, a wrench body unit 3, an electric unit 4, and a sensor unit 5.

In this embodiment, the tool head unit 1 includes an H- section 11, and a neck 12 that is connected to the H-section 11 and that extends along a first axis (X).

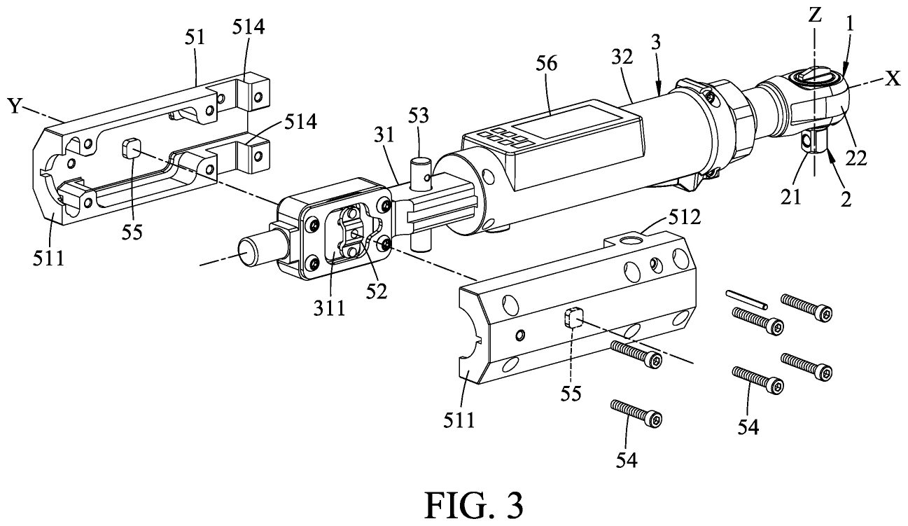

Referring to FIGS. 2 to 4, the output unit 2 includes a head driver 21 and a yoke 22.

The head driver 21 is mounted on the H-section 11 of the tool head unit 1, extends along a second axis (Z) transverse to the first axis (X), and is configured to rotate in a selected direction and output rotational energy. It should be noted that in this embodiment, the second axis (Z) is substantially perpendicular to the first axis (X).

The yoke 22 includes an annular toothed portion 221 that surrounds the head driver 21, and an activated portion 222 that is disposed in the neck 12.

The output unit 2 is known in the prior art and is not a distinctive feature of the disclosure; hence, it will not be discussed in further detail.

The wrench body unit 3 extends along the first axis (X), and includes a main body portion 31 and an installation portion 32. In this embodiment, the main body 31 has two mounting surfaces 311 spaced apart along a third axis (Y). The installation portion 32 is connected between the H-section 11 and the main body portion 31, and defines an installation space 321 that is elongated along the first axis (X). The third axis (Y) is substantially perpendicular to the first axis (X) and the second axis (Z).

The electric unit 4 is mounted in the installation portion 32, is operable for driving rotation of the head driver 21, and includes an electric motor 41, a transmitting subunit 42, and an activation button 43. The electric motor 41 is disposed in the installation space 321, and is operable for converting electric energy to kinetic energy. The transmitting subunit 42 is disposed between the activated portion 222 of the yoke 22 and the electric motor 41 (i.e., the transmitting subunit 42 is disposed between the head driver 21 and the electric motor 41), and is configured for transmitting kinetic energy to the head driver 21. The activation button 43 is disposed on the wrench body unit 3, and is operated to activate the electric motor 41.

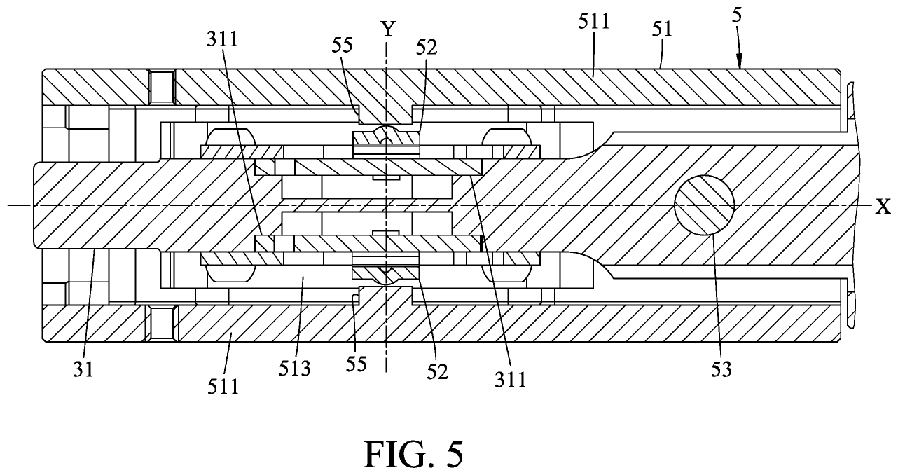

Referring to FIGS. 2, 3 and 5, the sensor unit 5 includes a transmitting handle 51 and at least one sensor module 52. The sensor unit 5 further includes a pin member 53, a plurality of fastening members 54, two actuating portions 55, and a display 56. In this embodiment, the at least one sensor module 52 includes two sensor modules 52.

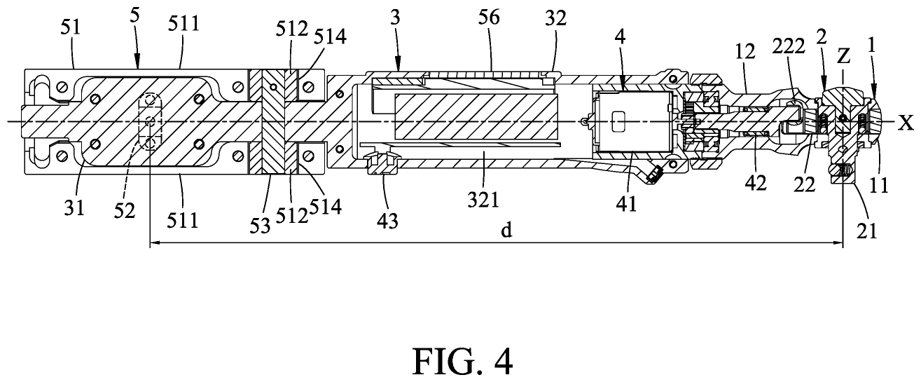

In this embodiment, the transmitting handle 51 surrounds the main body portion 31 and the sensor modules 52, and has two handle portions 511 coupled to each other and surrounding the main body portion 31. Specifically, one of the two handle portions 511 is pivotably connected to the main body portion 31, and includes two socket sections 512 (see FIG. 4) that are spaced apart along the second axis (Z). Another one of the two handle portions 511 has two groove sections 514 that are spaced apart along the second axis (Z), and that are engaged respectively with the socket sections 512. The handle portions 511 cooperatively define an insertion space 513 that has two open ends, and that accommodates the main body portion 31 and the sensor modules 52.

The sensor modules 52 are mounted respectively on the mounting surfaces 311, and are disposed between the main body portion 31 and the transmitting handle 51. More specifically, when the transmitting handle 51 is driven by an external force (F) to pivot relative to the main body portion 31, the sensor modules 52 outputs a torque reading of the external force (F). In this embodiment, the sensor modules 52 are load cells (not shown), and are operable for sensing the external force (F). Referring further to FIG. 4, a length of a torque arm (d) is defined by the distance along the first axis (X) between the sensor modules 52 and the rotational axis of the head driver 21 (i.e., the first axis (X)).

The pin member 53 removably extends in a direction of the second axis (Z) through the main body portion 31 of the wrench body unit 3. The socket sections 512 of the one of the handle portions 511 are rotatably sleeved on the pin member 53, such that the transmitting handle 51 is pivotable about the pin member 53 relative to the main body portion 31 and the sensor modules 52.

The fastening members 54 extend through the one of the handle portions 511 to the another one of the handle portions 511, and secures the handle portions 511 together.

Each of the actuating portions 55 is formed on an inner surface of a respective one of the handle portions 511, and faces respectively each of the sensor modules 52 for pushing the sensor modules 52 during pivot movement of the transmitting handle 51. In this embodiment, the actuating portions 55 are all protrusions extending respectively towards the sensor modules 52.

It should be noted that the actuating portions 55 are not limited to two protrusions; in other embodiments, the actuating portions 55 may be, for example, two recesses or one protrusion and one recess.

The display 56 is installed in the installation portion 32, is exposed from an outer surface of the installation portion 42, and is configured to display a torque value.

Referring to FIGS. 2, 4, 5, and 6, when a user grips the transmitting handle 51 and activates the electric motor 41 by pressing the activation button 43, kinetic energy from the electric motor 41 is transmitted by the transmission subunit 42 to drive the activated portion 222 of the yoke 22 to pivot, and to drive the head driver 21 to rotate about the second axis (Z) via the annular toothed portion 221, thereby allowing the electric ratchet wrench to fasten or loosen a screw or nut (not shown).

When the electric ratchet wrench of the embodiment is operated manually, the external force (F) is exerted by the user on the transmitting handle 51, and the tool head unit 1 and the wrench body unit 3 act collectively as a single torque arm to transmit rotational power to drive the head driver 21 to rotate, thereby allowing the electric ratchet wrench to fasten or loosen a screw or nut (not shown).

It should be noted that, when the embodiment of the electric ratchet wrench is operated manually, the electric motor 41 is inactive.

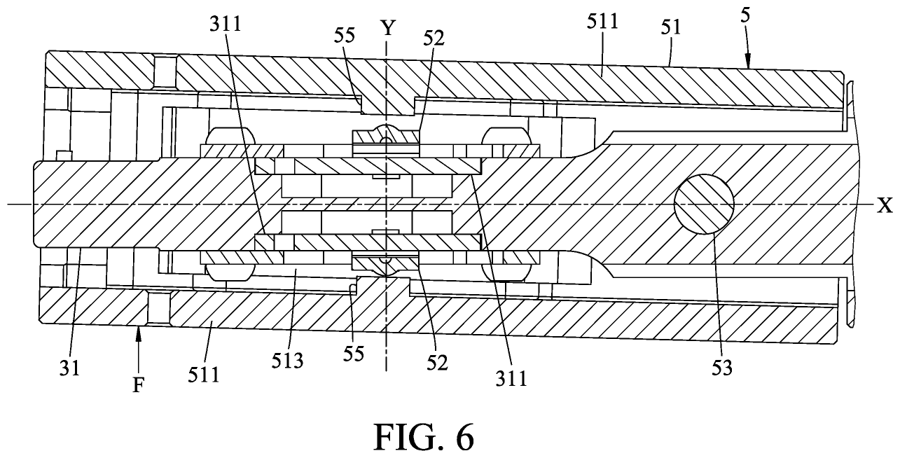

Specifically, when driven by the external force (F), the transmitting handle 51 pivots about the pin member 53 relative to the main body portion 31 in a direction of the external force (F); during this process, one of the actuating portions 55 presses a respective one of the sensor modules 52 (see FIG. 6), and the respective one of the sensor modules 52 outputs a torque value of the external force (F).

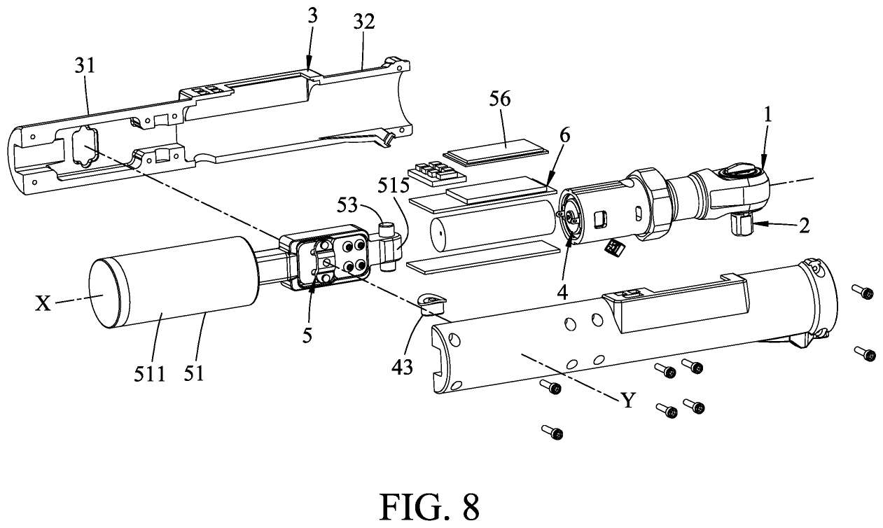

Hence, through the control unit 6 (see FIG. 8) that is electrically connected to the display 56 and the sensor modules 2, it is possible to calculate the torque value of the head driver 21 using a moment arm formula since the torque arm is already known, and display the torque value with the display 56. The moment arm formula states: torque (L)=length of torque arm (d)×external force (F).

It should be noted that, the displayed torque value is a corrected value of the calculated torque value that has been corrected by a correction factor; and the sensor modules 52 are not limited to load cells; in other embodiments, the sensor modules may be other kinds of sensors suitable for measuring torques.

Furthermore, the mounting surfaces 311 are not limited to being on the main body portion 31. In a variation of the first embodiment, the two mounting surfaces 311 are respectively formed on the handle portions 511, are opposite to each other along the third axis (Y), and faces the main body portion 31. The two sensor modules 52 are mounted respectively on the mounting surfaces 311. The two actuating portions 55 are formed on an outer surface of the main body portion 31, and face respectively the sensor modules 52 for pushing the sensor modules 52 during pivot movement of the transmitting handle 51.

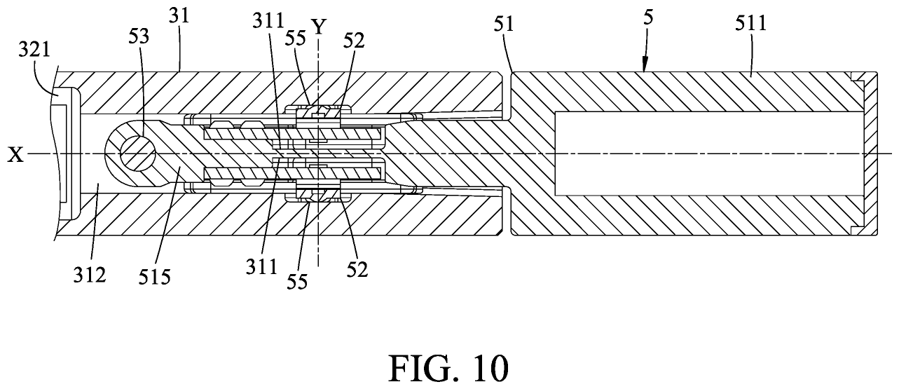

Referring to FIGS. 8 to 10, a second embodiment of the electric ratchet wrench according to the disclosure is similar to the first embodiment, the main difference resides in the following.

In this embodiment, the main body 31 is composed of two parts that are coupled together, has an outer diameter that is equal to an outer diameter of the installation portion 32, and defines a passage 312 that is elongated along the first axis (X).

The transmitting handle 51 of the second embodiment further has a connecting portion 515 disposed in the passage 312 and connected pivotably to the main body portion 31. The two mounting surfaces 311 are formed on the connecting portion 515 and are spaced apart along the third axis (Y). The handle portion 511 is opposite to the connecting portion 515, and is disposed outside the main body portion 31. The pin member 53 is removably and rotatably connected to the main body portion 31, and extends in the direction of the second axis (Z). In this embodiment, the at least one sensor modules 52 includes two sensor modules 52.

The sensor modules 52 are mounted respectively on the mounting surfaces 311, and are disposed between the connecting portion 515 and the main body portion 31.

The two actuating portions 55 are formed on an inner surface of the main body portion 31, and face respectively the sensor modules 52 for pushing the sensor modules 52 during pivot movement of the transmitting handle 51. In this embodiment, the actuating portions 55 are all recesses.

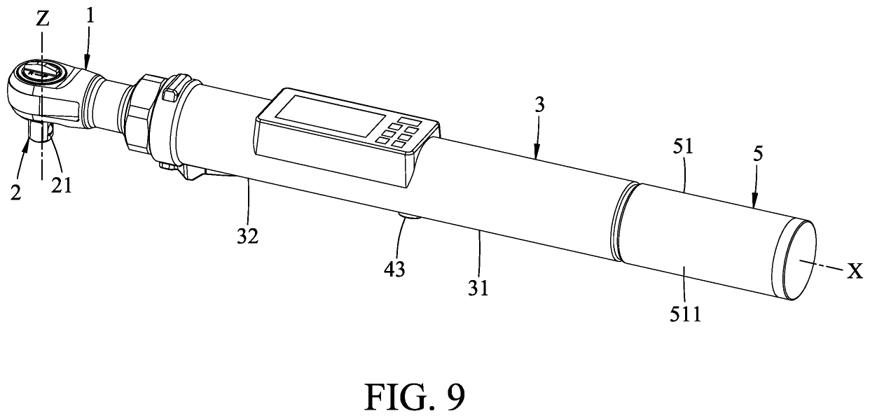

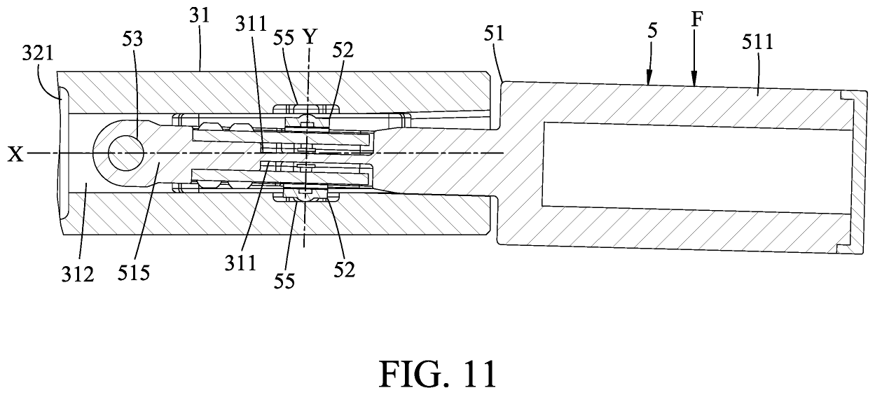

Referring to FIGS. 9 to 11, when driven by the external force (F), the transmitting handle 51 pivots about the pin member 53 relative to the main body portion 31 in the direction of the external force (F); during this process, one of the actuating portions 55 presses the respective one of the sensor modules 52 (see FIG. 11), and the respective one of the sensor modules 52 outputs a torque value. Hence, it is possible to calculate the torque value of the head driver 21 with the control unit 6 using the moment arm formula since the torque arm is already known, and the torque value may be displayed by the display 56. It should be noted that, when the electric ratchet wrench is operated manually, the motor is inactive, and the displayed torque value is a corrected value of the calculated torque value that has been corrected by a correction factor.

It should be noted that the actuating portions 55 are not limited to two recesses. In other embodiments, the actuating portions 55 may be, for example, two protrusions or one protrusion and one recess.

In conclusion, the advantages of the embodiments are as follows:

The sensitivity of the sensor modules 52 greatly increases by being proximal to the transmitting handle 51 which is directly affected by the external force (F).

Furthermore, keeping the sensor modules 52 from exposure to the external environment by mounting the sensor modules 52 between the transmitting handles 51 and the main body portion 31 protects the sensor modules 52 from impact and increases the lifespan of the electric ratchet wrench.

Moreover, the transmitting handle 51 may be separated from the main body portion 31 by removing the pin member 53 or simultaneously unfastening the fastening members 54, thereby making maintenance or replacement more convenient.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric ratchet wrench comprising:
a tool head unit;
a wrench body unit that extends along a first axis, and that includes a main body portion and an installation portion connected between said tool head unit and said main body portion;
an output unit that includes a head driver mounted on said tool head unit, extending along a second axis that is transverse to the first axis, and being configured to rotate in a selected direction and output rotational energy;
an electric unit that is mounted in said installation portion, and that is operable for driving rotation of said head driver; and
a sensor unit that includes
a transmitting handle pivotably connected to said main body portion, and
at least one sensor module disposed between said main body portion and said transmitting handle;
wherein, when said transmitting handle is driven by an external force to pivot relative to said main body portion, said sensor module outputs a torque reading of the external force.

2. The electric ratchet wrench as claimed in claim 1, wherein:
said installation portion defines an installation space that is elongated along the first axis; and
said electric unit includes
an electric motor that is disposed in said installation space, and that is operable for converting electric energy to kinetic energy, and
a transmission subunit that is disposed between said head driver and said electric motor, and that is configured for transmitting kinetic energy to said head driver.

3. The electric ratchet wrench as claimed in claim 1, wherein:
the first axis is substantially perpendicular to the second axis;
said main body portion of said wrench body unit has two mounting surfaces spaced apart along a third axis that is substantially perpendicular to the first axis and the second axis;
said at least one sensor module includes two sensor modules respectively mounted on said mounting surfaces; and
said transmitting handle surrounds said main body portion and said sensor modules.

4. The electric ratchet wrench as claimed in claim 3, wherein said sensor unit further includes two actuating portions formed on an inner surface of said transmitting handle, and facing respectively said sensor modules for pushing said sensor modules during pivot movement of said transmitting handle.

5. The electric ratchet wrench as claimed in claim 1, wherein:
the first axis is substantially perpendicular to the second axis;
said transmitting handle surrounds said main body portion, and has two mounting surfaces opposite to each other along a third axis that is substantially perpendicular to the first axis and the second axis, and facing said main body portion;
said at least one sensor module includes two sensor modules mounted respectively on said mounting surfaces.

6. The electric ratchet wrench as claimed in claim 5, wherein:
said sensor unit further includes two actuating portions formed on an outer surface of said main body portion, and facing respectively said sensor modules for pushing said sensor modules during pivot movement of said transmitting handle.

7. The electric ratchet wrench as claimed in claim 3, wherein:
said transmitting handle has two handle portions coupled to each other and surrounding said main body portion;
one of said handle portions is pivotably connected to said main body portion; and
said handle portions cooperatively define an insertion space that has two open ends and that accommodates said main body portion and said sensor modules.

8. The electric ratchet wrench as claimed in claim 7, wherein:
said sensor unit further includes a pin member that extends through said main body portion in a direction of the second axis;
said one of said handle portions includes two socket sections that are spaced apart along the second axis, and that are rotatably sleeved on said pin member; and
another one of said handle portions has two groove sections that are spaced apart along the second axis, and that are engaged respectively with said socket sections.

9. The electric ratchet wrench as claimed in claim 7, wherein said sensor unit further includes a plurality of fastening members securing said handle portions together.

10. The electric ratchet wrench as claimed in claim 1, wherein said at least one sensor module is at least one load cell.

11. The electric ratchet wrench as claimed in claim 1, wherein:
said main body portion defines a passage being elongated along the first axis;
said transmitting handle has
a connecting portion disposed in said passage, and connected pivotably to said main body portion, and
a handle portion opposite to said connecting portion, and disposed outside the main body portion; and
said at least one sensor module is disposed between said connecting portion and said main body portion.

12. The electric ratchet wrench as claimed in claim 11, wherein:
the first axis is substantially perpendicular to the second axis;
said at least one sensor module includes two sensor modules;
said connecting portion of said transmitting handle has two mounting surfaces spaced apart along a third axis that is substantially perpendicular to the first axis and the second axis; and
said sensor modules are mounted respectively on said mounting surfaces.

13. The electric ratchet wrench as claimed in claim 12, wherein said sensor unit further includes two actuating portions formed on an inner surface of said main body portion, and facing respectively said sensor modules for pushing said sensor modules during pivot movement of said transmitting handle.

14. The electric ratchet wrench as claimed in claim 13, wherein each of said actuating portions is one of a protrusion and a recess.

15. The electric ratchet wrench as claimed in claim 4, wherein each of said actuating portions is one of a protrusion and a recess.

16. The electric ratchet wrench as claimed in claim 6, wherein each of said actuating portions is one of a protrusion and a recess.

17. The electric ratchet wrench as claimed in claim 5, wherein:
said transmitting handle has two handle portions coupled to each other and surrounding said main body portion;
said mounting surfaces are respectively formed on said handle portions;
one of said handle portions is pivotably connected to said main body portion; and
said handle portions cooperatively define an insertion space that has two open ends and that accommodates said main body portion and said sensor modules.

18. The electric ratchet wrench as claimed in claim 17, wherein:
said sensor unit further includes a pin member that extends through said main body portion along the second axis;
said one of said handle portions includes two socket sections that are spaced apart along the second axis, and that are rotatably sleeved on said pin member; and
another one of said handle portions has two groove sections that are spaced apart along the second axis, and that are engaged respectively with said socket sections.

19. The electric ratchet wrench as claimed in claim 17, wherein said sensor unit further includes a plurality of fastening members securing said handle portions together.
